(19) United States
(12) Patent Application Publication
(10) Pub. No.: US 2026/0073563 A1
(43) Pub. Date: Mar. 12, 2026

(54) LEARNING DEVICE, IMAGE PROCESSING DEVICE, LEARNING METHOD, IMAGE PROCESSING METHOD, AND COMPUTER PROGRAM

(71) Applicant: NIPPON TELEGRAPH AND TELEPHONE CORPORATION, Tokyo (JP)

(72) Inventors: Kana KURATA, Tokyo (JP); Yasuhiro YAO, Tokyo (JP); Shingo ANDO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 19/106,566

(22) PCT Filed: Aug. 26, 2022
(86) PCT No.: PCT/JP2022/032202

§ 371 Date: Feb. 25, 2025

(51) Int. Cl. G06T 7/90; G06T 7/70

(52) U.S. Cl. CPC G06T 7/90; G06T 7/70; G06T 2207/20081; G06T 2207/20084

(57) ABSTRACT

Provided is a learning device 10 including: an acquisition unit 101 that acquires three-dimensional coordinate values, information on a line-of-sight direction, and point cloud data as input data and images captured from a plurality of directions as teacher data; and a learning unit 102 that learns a model for outputting an image from a designated line-of-sight direction by outputting a color and a density for each pixel using the input data and the teacher data.

### TECHNICAL FIELD

The disclosed technology relates to a learning device, an image processing device, a learning method, an image processing method, and a computer program.

### BACKGROUND ART

Non Patent Literature 1 proposes a “neural radiance field (NeRF)”, which is a volume representation by a deep neural network (DNN) that synthesizes an image from a new viewpoint on the basis of an image set. In NeRF, one scene is represented by one DNN, and parameters of the DNN are optimized on the basis of images from a large number of viewpoints so as to return appropriate R (red), G (green), B (blue), and σ (transmittance) with coordinates in a three-dimensional space and information on a two-dimensional line-of-sight direction (polar angle θ and azimuth angle φ) as inputs.

### CITATION LIST

### Non Patent Literature

Non Patent Literature 1: Mildenhall, B., Srinivasan, P. P., Tancik, M., Barron, J. T., Ramamoorthi, R., Ng, R., “NeRF: Representing Scenes as Neural Radiance Fields for View Synthesis.”, the Internet <URL: https: //arxiv. org/pdf/2003.08934.pdf>

### SUMMARY OF INVENTION

### Technical Problem

In order to create a three-dimensional map of a city, it is required to acquire only arrangement information of stationary objects such as buildings and facilities without including moving objects such as pedestrians and cars. In order to acquire the information of the stationary objects, it is conceivable to acquire data at night, when few moving objects appear and there are few scene changes caused by changes in arrangement of a standing signboard and the like. However, since there is no sunlight irradiation at night, it is difficult to acquire color information by a passive sensor such as a visible light camera. On the other hand, in an observation by an active sensor such as light detection and ranging (LIDAR), shape information of objects can be efficiently acquired at night, when few moving objects appear, but color information in a wavelength other than the laser wavelength cannot be acquired. Therefore, it is difficult to identify an object stuck to a road surface or a wall surface in some cases, and the difficulty of annotation of objects by visual observation increases. For this reason, it is conceivable to support the identification by assigning RGB based on an RGB image acquired in the daytime to the shape information (point cloud data in the present disclosure) visualized by a work tool at the time of the work of the annotation or the like and displaying the obtained image. However, in the assignment of R, G, and B by simple superimposition, there are problems that R, G, and B values cannot be assigned outside the range of the image, and moving objects appearing in the RGB image in the daytime are transferred.

The disclosed technology has been made in view of the above points, and an object thereof is to provide a learning device, an image processing device, a learning method, an image processing method, and a computer program for generating an arbitrary viewpoint image to which RGB is assigned even outside a field angle range.

### Solution to Problem

The first aspect of the present disclosure is a learning device including: an acquisition unit that acquires three-dimensional coordinate values, information on a line-of-sight direction, and point cloud data as input data and images captured from a plurality of directions as teacher data; and a learning unit that learns a model for outputting an image from a designated line-of-sight direction by outputting a color and a density for each pixel using the input data and the teacher data.

The second aspect of the present disclosure is an image processing device including: an estimation unit that inputs a line-of-sight direction to a learned model for outputting an image from a designated line-of-sight direction by outputting a color and a density for each pixel using three-dimensional coordinate values, information on a line-of-sight direction, and point cloud data as input data and images captured from a plurality of directions as teacher data, and causes the model to output a color and a transmittance for each pixel from the line-of-sight direction; and an image processing unit that generates an image from the line-of-sight direction using the color and the transmittance output by the estimation unit.

The third aspect of the present disclosure is a learning method in which a processor executes processing of: acquiring three-dimensional coordinate values, information on a line-of-sight direction, and point cloud data as input data and images captured from a plurality of directions as teacher data; and learning a model for outputting an image from a designated line-of-sight direction by outputting a color and a density for each pixel using the input data and the teacher data.

The fourth aspect of the present disclosure is an image processing method in which a processor executes processing of: inputting a line-of-sight direction to a learned model for outputting an image from a designated line-of-sight direction by outputting a color and a density for each pixel using three-dimensional coordinate values, information on a line-of-sight direction, and point cloud data as input data and images captured from a plurality of directions as teacher data, and causing the model to output a color and a transmittance for each pixel from the line-of-sight direction; and generating an image from the line-of-sight direction using the color and the transmittance.

The fifth aspect of the present disclosure is a computer program for causing a computer to function as the learning device according to the first aspect of the present disclosure or the image processing device according to the second aspect of the present disclosure.

### Advantageous Effects of Invention

According to the disclosed technology, it is possible to provide a learning device, an image processing device, a learning method, an image processing method, and a computer program for generating an arbitrary viewpoint image to which RGB is assigned even outside a field angle range.

### BRIEF DESCRIPTION OF DRAWINGS

FIG. 1 is a diagram illustrating an example of an image processing system of an embodiment.

FIG. 2 is a block diagram illustrating a hardware configuration of a learning device.

FIG. 3 is a block diagram illustrating an example of a functional configuration of the learning device.

FIG. 4 is a block diagram illustrating a hardware configuration of an image processing device.

FIG. 5 is a block diagram illustrating an example of a functional configuration of the image processing device.

FIG. 6 is a diagram for describing an outline of learning processing in NeRF

FIG. 7 is a diagram for describing an outline of learning processing in the learning device.

FIG. 8 is a diagram for describing an outline of learning processing in the learning device.

FIG. 9 is a diagram for describing an outline of learning processing in the learning device.

FIG. 10 is a flowchart illustrating a flow of learning processing by the learning device.

FIG. 11 is a flowchart illustrating a flow of image processing by the image processing device.

### DESCRIPTION OF EMBODIMENTS

Hereinafter, an example of an embodiment of the disclosed technology will be described with reference to the drawings. Note that, in the drawings, the same or equivalent components and portions are denoted by the same reference signs. In addition, dimensional ratios in the drawings are exaggerated for convenience of description, and may be different from actual ratios.

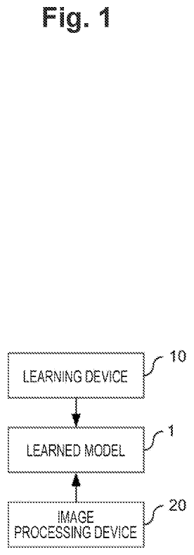

FIG. 1 is a diagram illustrating an example of an image processing system of the present embodiment. The image processing system according to the present embodiment includes a learning device 10 and an image processing device 20.

The learning device 10 is a device that executes learning processing on a model using images captured from a plurality of directions, point cloud data, and viewpoint information, and generates a learned model 1 that outputs information for generating an image from an arbitrary viewpoint.

At the time of learning of the learned model 1, the learning device 10 performs learning of the learned model 1 so as to output, as output data, appropriate R (red), G (green), and B (blue) values and σ (transmittance) that reduce an error from teacher data, using coordinates of a three-dimensional space on a line of sight of each pixel in an image from a certain viewpoint, information on a line-of-sight direction, and point cloud data as input data and an image captured from the viewpoint as the teacher data. Specific examples of the learning processing by the learning device 10 will be described in detail later. In addition, the same coordinate system is used for the coordinates of the three-dimensional space, the information on the line-of-sight direction, and the point cloud data as inputs. The point cloud data can be acquired with, for example, an active sensor such as LiDAR.

The image processing device 20 is a device that inputs information on a viewing angle from a viewpoint from which an image is desired to be generated to the learned model 1, and generates the image from the viewpoint using R, G, and B values and σ (transmittance) for each pixel output from the learned model 1.

The learning device 10 uses not only the coordinates of the three-dimensional space and the information on the two-dimensional viewing angle from the certain viewpoint but also the point cloud data, and thus can perform learning processing for representing three-dimensional information with a DNN, which is assisted by three-dimensional shape information from the point cloud. By performing such learning processing, the learning device 10 can generate the learned model 1 for generating an image from an arbitrary viewpoint to which R, G, and B are assigned even outside a field angle range.

In addition, the image processing device 20 inputs information on a viewing angle to the learned model 1 learned by the learning device 10 and thus can generate an image from an arbitrary viewpoint to which R, G, and B are assigned even outside a field angle range.

Note that, in the image processing system illustrated in FIG. 1, the learning device 10 and the image processing device 20 are separate devices, but the present disclosure is not limited to such an example, and the learning device 10 and the image processing device 20 may be the same device. Furthermore, the learning device 10 may include a plurality of devices.

Next, a configuration of the learning device 10 will be described.

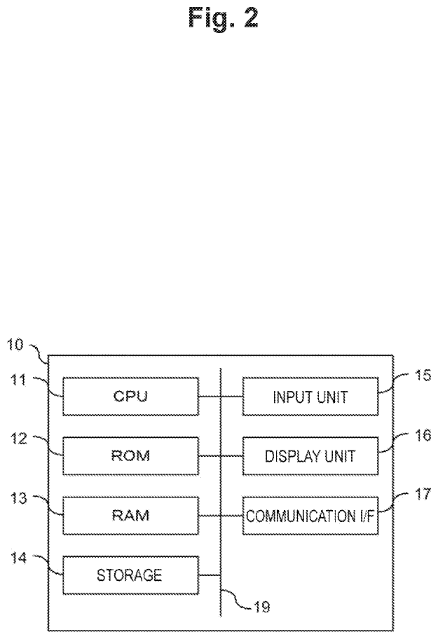

FIG. 2 is a block diagram illustrating a hardware configuration of the learning device 10.

As illustrated in FIG. 2, the learning device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 19.

The CPU 11 is a central processing unit that executes various programs and controls each unit. That is, the CPU 11 reads a program from the ROM 12 or the storage 14, and executes the program using the RAM 13 as a work area. The CPU 11 performs control of each of the components described above and various types of arithmetic processing in accordance with the program stored in the ROM 12 or the storage 14. In the present embodiment, the ROM 12 or the storage 14 stores a learning processing program for generating the learned model 1 that executes learning processing and outputs information for generating an image from an arbitrary viewpoint.

The ROM 12 stores various programs and various types of data. The RAM 13 temporarily stores programs or data as a work area. The storage 14 includes a storage device such as a hard disk drive (HDD) or a solid state drive (SSD), and stores various programs including an operating system and various types of data.

The input unit 15 includes a pointing device such as a mouse and a keyboard, and is used to perform various inputs.

The display unit 16 is, for example, a liquid crystal display and displays various types of information. The display unit 16 may function as the input unit 15 by adopting a touch panel system.

The communication interface 17 is an interface for communicating with other devices. For the communication, for example, a wired communication standard such as Ethernet (registered trademark) or FDDI, or a wireless communication standard such as 4G, 5G, or Wi-Fi (registered trademark) is used.

Next, a functional configuration of the learning device 10 will be described.

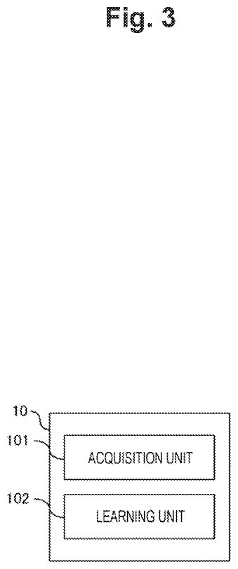

FIG. 3 is a block diagram illustrating an example of the functional configuration of the learning device 10.

As illustrated in FIG. 3, the learning device 10 includes an acquisition unit 101 and a learning unit 102 as functional configurations. Each functional configuration is implemented by the CPU 11 reading the learning processing program stored in the ROM 12 or the storage 14, developing the learning processing program in the RAM 13, and executing the learning processing program.

The acquisition unit 101 acquires data used for learning processing. In the present embodiment, the acquisition unit 101 acquires three-dimensional spatial coordinates in a line-of-sight direction of each pixel in an image from a certain viewpoint, information on a two-dimensional viewing angle, and point cloud data as input. data, and an image captured from the viewpoint as teacher data.

The learning unit 102 performs learning of the learned model 1 so as to output, as output data, appropriate R (red), G (green), and B (blue) values and o (transmittance) that reduce an error from the teacher data, using the three-dimensional spatial coordinates in the line-of-sight direction of each pixel in the image from the certain viewpoint, the information on the viewing angle, and the point cloud data as input data and the image captured from the viewpoint as the teacher data, which have been acquired by the acquisition unit 101.

Next, a configuration of the image processing device 20 will be described.

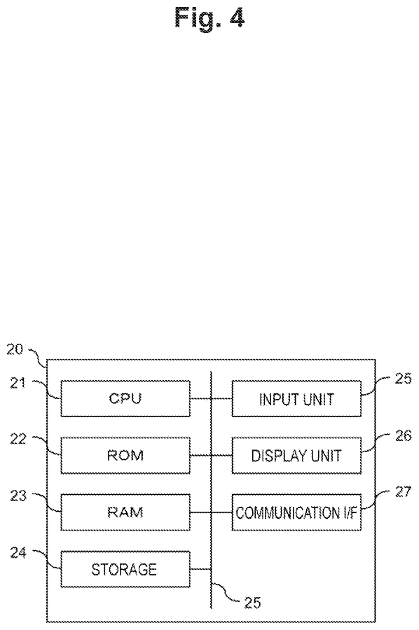

FIG. 4 is a block diagram illustrating a hardware configuration of the image processing device 20.

As illustrated in FIG. 4, the image processing device 20 includes a CPU 21, a ROM 22, a RAM 23, a storage 24, an input unit 25, a display unit 26, and a communication interface (I/F) 27. The components are communicably connected to each other via a bus 29.

The CPU 21 is a central processing unit that executes various programs and controls each unit. That is, the CPU 21 reads a program from the ROM 22 or the storage 24, and executes the program using the RAM 23 as a work area. The CPU 21 performs control of each of the components described above and various types of arithmetic processing in accordance with the program stored in the ROM 22 or the storage 24. In the present embodiment, the ROM 12 or the storage 14 stores an image processing program for inputting information on a viewing angle from a certain viewpoint to the learned model 1 and generating an image from the viewpoint using information output by the learned model 1.

The ROM 22 stores various programs and various types of data. The RAM 23 temporarily stores programs or data as a work area. The storage 24 includes a storage device such as an HDD or an SSD, and stores various programs including an operating system and various types of data.

The input unit 25 includes a pointing device such as a mouse and a keyboard, and is used to perform various inputs.

The display unit 26 is, for example, a liquid crystal display, and displays various types of information. The display unit 26 may function as the input unit 25 by adopting a touch panel system.

The communication interface 27 is an interface for communicating with other devices. For the communication, for example, a wired communication standard such as Ethernet (registered trademark) or FDDI, or a wireless communication standard such as 4G, 5G, or Wi-Fi (registered trademark) is used.

Next, a functional configuration of the image processing device 20 will be described.

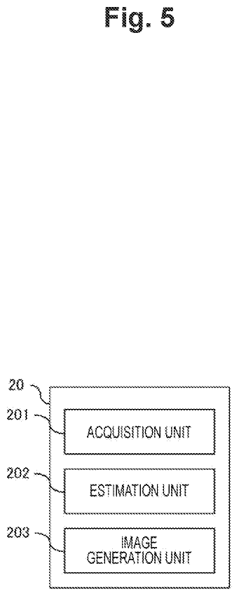

FIG. 5 is a block diagram illustrating an example of the functional configuration of the image processing device 20.

As illustrated in FIG. 5, the image processing device 20 includes an acquisition unit 201, an estimation unit 202, and an image generation unit 203 as functional configurations. Each functional configuration is implemented by the CPU 21 reading the image processing program stored in the ROM 22 or the storage 24, developing the image processing program in the RAM 23, and executing the image processing program.

The acquisition unit 201 acquires information on a line-of-sight direction of a viewpoint from which an image is desired to be generated. The information on the line-of-sight direction (information on a viewing angle) is input by a user via a predetermined user interface displayed on the display unit 26 by the image processing device 20, for example.

The estimation unit 202 inputs the information on the line-of-sight direction acquired by the acquisition unit 201 to the learned model 1, and causes the learned model 1 to output a color and a transmittance for each pixel from the line-of-sight direction, thereby estimating an image from the line-of-sight direction.

The image generation unit 203 generates and outputs the image from the viewpoint on the basis of the estimation result by the estimation unit 202 about the image from the viewpoint of the viewing angle acquired by the acquisition unit 201.

With such a configuration, the image processing device 20 can generate an arbitrary viewpoint image to which RGB is assigned even outside a field angle range using the learned model 1.

Next, actions of the learning device 10 will be described.

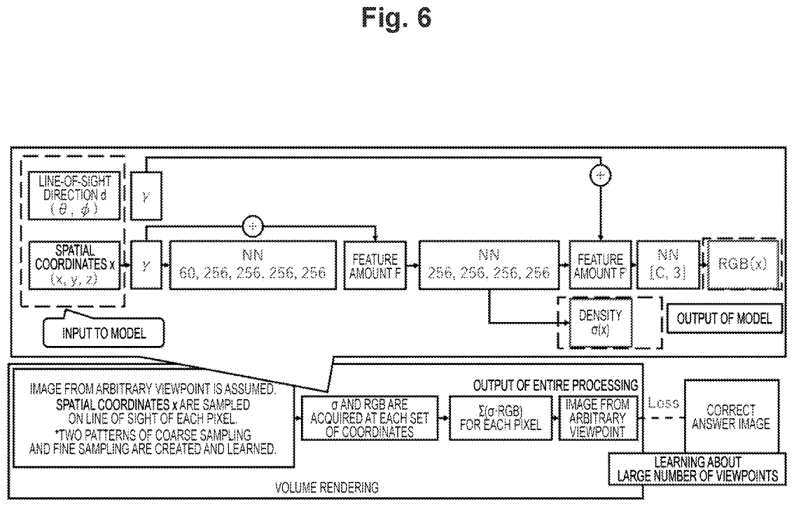

First, an outline of learning processing in NeRF will be described. FIG. 6 is a diagram illustrating the outline of learning processing in NeRF.

In NeRF, an image from an arbitrary viewpoint is assumed, and spatial coordinates x are sampled on a line of sight corresponding to each pixel. At the time of learning, the image from the arbitrary viewpoint assumes a viewpoint of a correct answer image. In addition, in NeRE, two patterns of coarse sampling and fine sampling are created and learned at the time of learning.

When the spatial coordinates x (x, y, z) and a line-of-sight direction d(θ, φ) are input, a NeRF model outputs R, G, and B values RGB(x) at the spatial coordinates x and a density value σ(x) at the spatial coordinates x. The model is configured as illustrated in FIG. 6. For the line-of-sight direction d(θ, φ), parameters of the correct answer image are used at the time of learning. The spatial coordinates x (x, y, z) in the line-of-sight direction corresponding to each pixel are not included in the correct answer image acquired by a camera instead of rendering, and thus are generated by sampling.

The spatial coordinates x are input to a function y and then input to a five-layer neural network having the number of nodes of 60, 256, 256, 256, and 256. A feature amount F after passing through the five-layer neural network is further combined with the spatial coordinates X input to the function Y, and is input to a four-layer neural network having the number of nodes of 256, 256, 256, and 256. The value after passing through the four-layer neural network is output as the density value σ(x). Furthermore, the value after passing through the four-layer neural network is combined with the line-of-sight direction d input to the function γ to become a feature amount F′, and the feature amount F′ is input to a neural network. The value after passing through the neural network is output as RGB(x).

When the NeRF model outputs RGB(x) and σ(x) of all pixels, the image from the arbitrary viewpoint is generated by volume rendering. The NeRF model is then learned to reduce an error between the image generated by the NeRF model and the correct answer image from the viewpoint.

In the NeRF model, in a case where an image acquired at night is used as a correct answer image, there is a problem that R, G, and B values cannot be assigned outside the range of the image. Therefore, the learning device 10 according to the present embodiment performs learning of the learned model 1 using point cloud data in addition to the spatial coordinates x and the line-of-sight direction d.

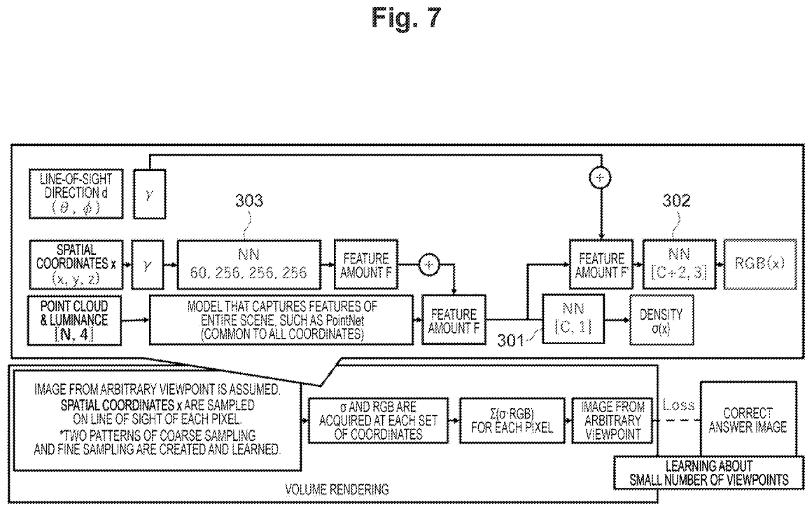

FIG. 7 is a diagram for describing an outline of learning processing in the learning device 10. The learning processing illustrated in FIG. 7 has a configuration that emphasizes assistance of learning of a three-dimensional shape using a point cloud, and assigns R, G, and B using a position in a scene as a clue. This configuration is effective, for example, in a scene where a color changes according to a position (for example, in a case where colors of a floor, a ceiling, and a wall are unified in an indoor room or the like). The framework for learning a deep neural network is similar to the learning of a model in NeRF described with reference to FIG. 6, in that the learning of the deep neural network is performed on the basis of a generated image, which is a result of volume rendering, and a correct answer image, and that two patterns of coarse sampling and fine sampling are created and learned at the time of learning, but a point cloud of an area corresponding to the correct answer image is added to the input to the deep neural network. In this case, the same coordinate system is used for the point cloud and camera position coordinates. For example, in a case where the point cloud is represented in an orthogonal coordinate system and the camera position coordinates are represented in a geographic coordinate system (latitude, longitude), the point cloud and the camera position coordinates are aligned in the same coordinate system in advance by use of. a corresponding coordinate system conversion method. Since the orthogonal coordinate system is often used in point cloud processing and a NeRF algorithm, alignment in the orthogonal coordinate system makes it easier to implement a program than that in the geographic coordinate system.

Spatial coordinates x are input to a function γ and then input to a four-layer third neural network 303 having the number of nodes of 60, 256, 256, and 256. In addition, point cloud data including a point cloud and a luminance is input to a model that captures features of the entire Scene, such as PointNet. The output of the model is combined with the output from the four-layer neural network to become a feature amount F.

The feature amount F is input to a predetermined first neural network. The value after passing through a first neural network 301 is output as a density value σ(x). Furthermore, the feature amount F is combined with a line-of-sight direction d input to the function γ to become a feature amount F′, and the feature amount F′ is input to a second neural network 302. The value after passing through the second neural network 302 is output as RGB(x).

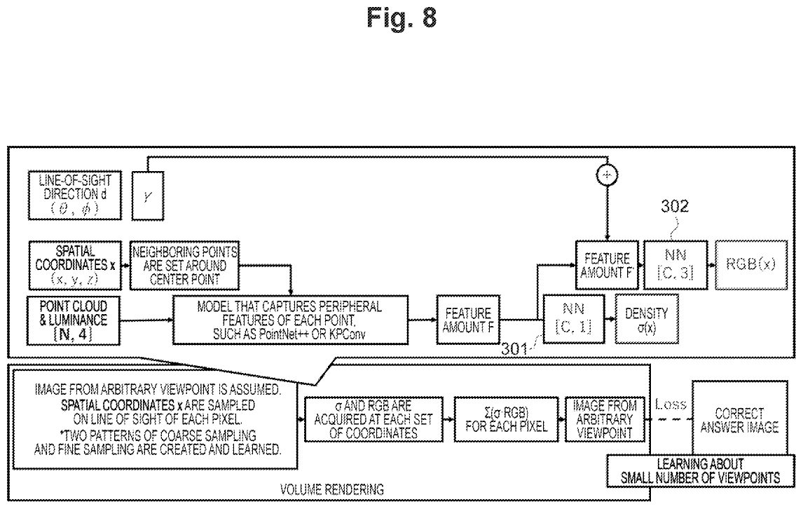

FIG. 8 is a diagram for describing an outline of learning processing in the learning device 10. The learning processing illustrated in FIG. 8 has a configuration that emphasizes estimation of a color based on local shape information and luminance information from a point cloud, and assigns R, G, and B using a local shape as a clue. This configuration is effective, for example, in a scene where a color changes corresponding to a local shape (for example, an outdoor scene where trees and utility poles are mixed). Two patterns of coarse sampling and fine sampling are created and learned at the time of learning, which is similar to the learning of a model in NeRF described with reference to FIG. 6.

Point cloud data including a point cloud and a luminance is input to a model that captures peripheral features of each point, such as PointNet++ or KPConv. In addition, neighboring points are set with the point of spatial coordinates x as the center point, and the neighboring points are input to the model that captures peripheral features. By the input to the model, local features are extracted, and R, G, and B are assigned on the basis of the local features. The output of the model is a feature amount F.

The feature amount F is input to the predetermined first neural network 301. The value after passing through the first neural network 301 is output as a density value σ(x). Furthermore, the feature amount F is combined with a line-of-sight direction d input to a function γ to become a feature amount F′, and the feature amount F′ is input to the predetermined second neural network 302. The value after passing through the second neural network 302 is output as RGB(x).

The learning device 10 performs learning of the learned model 1 so as to reduce an error between an image from an arbitrary viewpoint generated from RGB(x) and σ(x) output from the learned model 1 and a correct answer image. Here, at the time of learning of the learned model 1, the learning device 10 calculates the error only with coordinates overlapping with the correct answer image. A place not overlapping with the correct answer image is colored in synchronization with a learning target area.

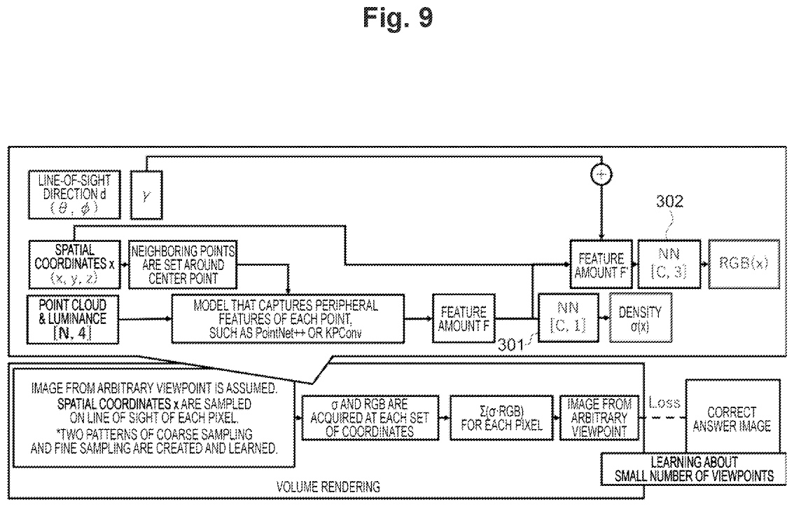

FIG. 9 is a diagram for describing an outline of learning processing in the learning device 10. The learning processing illustrated in FIG. 9 has a configuration that emphasizes estimation of a color based on local shape information, luminance information, and coordinates from a point cloud, and assigns R, G, and B using both a position in a scene and a local shape as clues. This configuration is effective, for example, in an outdoor scene where the color of a road or a sidewalk is constant and trees and utility poles are mixed, Two patterns of coarse sampling and fine sampling are created and learned at the time of learning, which is similar to the learning of a model in NeRF described with reference to FIG. 6.

In the learning processing illustrated in FIG. 9, in addition to the learning processing illustrated in FIG. 8, a feature amount associated with a position in a space, which is obtained by non-linear transformation of spatial coordinates x by a neural network, is combined with a feature amount F to generate a feature amount F′. The learning device 10 adds information on the spatial coordinates x at the time of generating the feature amount F′, and thus can perform learning of the learned model 1 that performs color estimation in consideration of a relative position in a target area together with a local shape feature.

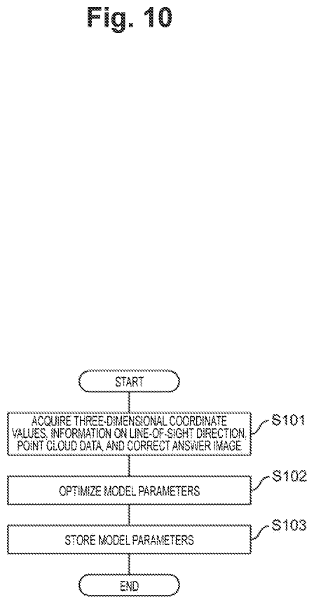

FIG. 10 is a flowchart illustrating a flow of learning processing by the learning device 10. The learning processing is performed by the CPU 11 reading the learning processing program from the ROM 12 or the storage 14, developing the learning processing program in the RAM 13, and executing the learning processing program.

In step S101, the CPU 11 acquires three-dimensional coordinate values, information on a line-of-sight direction, point cloud data, and a correct answer image that is an image captured from the line-of-sight direction, which are used for the learning processing.

Following step S101, in step S102, the CPU 11 optimizes model parameters of the learned model 1 using the three-dimensional coordinate values, the information on the line-of-sight direction, and the point cloud data as input data and the correct answer image as teacher data. The CPU 11 optimizes the model parameters of the learned model 1, for example, by executing any one set of the learning processing of FIGS. 7 to 9.

Following step S102, in step S103, the CPU 11 stores the optimized model parameters of the learned model 1.

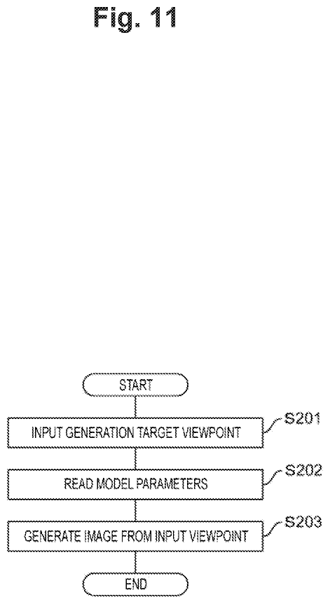

FIG. 11 is a flowchart illustrating a flow of image processing by the image processing device 20. The image processing is performed by the CPU 21 reading the image processing program from the ROM 22 or the storage 24, developing the image processing program in the RAM 23, and executing the image processing program.

In step S201, the CPU 21 acquires information on a generation target viewpoint for generating an image with the learned model 1.

Following step S201, in step S202, the CPU 21 reads model parameters of the learned model 1.

Following step S202, in step S203, the CPU 21 inputs the information on the generation target viewpoint to the learned model 1 from which the model parameters have been read, and generates an image from the target viewpoint using a color and a transmittance for each pixel output from the learned model 1.

Note that the learning processing and the image processing executed by the CPUs reading software (programs) in each of the above embodiments may be executed by various processors other than the CPUs. Examples of the processors in this case include a programmable logic device (PLD), a circuit configuration of which can be changed after manufacturing, such as a field-programmable gate array (FPGA), and a dedicated electric circuit that is a processor having a circuit configuration exclusively designed for executing specific processing, such as an application specific integrated circuit (ASIC). Furthermore, the learning processing and the image processing may be executed by one of these various processors, or may be executed by a combination of two or more processors of the same type or different types (for example, a plurality of FPGAS, a combination of a CPU and an FPGA, or the like). Furthermore, hardware structures of these various processors are, more specifically, electric circuits in each of which circuit elements such as semiconductor elements are combined.

In each of the above embodiments, an aspect has been described in which the learning processing program is stored (installed) in advance in the storage 14 and the image processing program is stored (installed) in advance in the storage 24, but the disclosed technology is not limited thereto. The programs may be provided by being stored in a non-transitory storage medium such as a compact disk read only memory (CD-ROM), a digital versatile disk read only memory (DVD-ROM), and a universal serial bus (USB) memory. Moreover, the programs may be downloaded from an external device via a network.

With regard to the above embodiment, the following supplementary notes are further disclosed.

### Supplementary Note 1

A learning device including:
a memory; and
at least one processor connected to the memory, wherein
the processor is configured
to acquire three-dimensional coordinate values, information on a line-of-sight direction, and point cloud data as input data and images captured from a plurality of directions as teacher data, and
to learn a model for outputting an image from a designated line-of-sight direction by outputting a color and a density for each pixel using the input data and the teacher data.

### Supplementary Note 2

An image processing device including:
a memory; and
at least one processor connected to the memory, wherein
the processor is configured
to input a line-of-sight direction to a learned model for outputting an image from a designated line-of-sight direction by outputting a color and a density for each pixel using three-dimensional coordinate values, information on a line-of-sight direction, and point cloud data as input data and images captured from a plurality of directions as teacher data, and cause the model to output a color and a transmittance for each pixel from the line-of-sight direction, and
to generate an image from the line-of-sight direction using the color and the transmittance.

### Supplementary Note 3

A non-transitory storage medium storing a program executable by a computer to execute learning processing, wherein
the learning processing includes:
acquiring three-dimensional coordinate values, information on a line-of-sight direction, and point cloud data as input data and images captured from a plurality of directions as teacher data; and
learning a model for outputting an image from a designated line-of-sight direction by outputting a color and a density for each pixel using the input data and the teacher data.

### Supplementary Note 4

A non-transitory storage medium storing a program executable by a computer to perform image processing, wherein
the image processing includes:
inputting a line-of-sight direction to a learned model for outputting an image from a designated line-of-sight direction by outputting a color and a density for each pixel using three-dimensional coordinate values, information on a line-of-sight direction, and point cloud data as input data and images captured from a plurality of directions as teacher data, and causing the model to output a color and a transmittance for each pixel from the line-of-sight direction; and
generating an image from the line-of-sight direction using the color and the transmittance.

### REFERENCE SIGNS LIST

1 Learned model
10 Learning device
20 Image processing device

1. A learning device comprising:
an acquisition unit that acquires three-dimensional coordinate values, information on a line-of-sight direction, and point cloud data as input data and images captured from a plurality of directions as teacher data; and
a learning unit that learns a model for outputting an image from a designated line-of-sight direction by outputting a color and a density for each pixel using the input data and the teacher data.

2. The learning device according to claim 1, wherein the learning unit learns the model so as to output the density for each pixel by inputting a first feature amount obtained from the point cloud data and the three-dimensional coordinate values to a predetermined first neural network, and to output the color for each pixel by inputting a feature amount obtained from the information on the line-of-sight direction and the first feature amount to a predetermined second neural network.

3. The learning device according to claim 2, wherein the first feature amount is obtained from a feature amount obtained by inputting the three-dimensional coordinate values to a predetermined third neural network and a feature amount obtained by inputting the point cloud data to a predetermined model.

4. The learning device according to claim 2, wherein the first feature amount is obtained from neighboring points set with the three-dimensional coordinate values as a center point and a feature amount obtained by inputting the point cloud data to a predetermined model.

5. An image processing device comprising:
an estimation unit that inputs a line-of-sight direction to a learned model for outputting an image from a designated line-of-sight direction by outputting a color and a density for each pixel using three-dimensional coordinate values, information on a line-of-sight direction, and point cloud data as input data and images captured from a plurality of directions as teacher data, and causes the model to output a color and a transmittance for each pixel from the line-of-sight direction; and
an image processing unit that generates an image from the line-of-sight direction using the color and the transmittance output by the estimation unit.

6. A learning method in which a processor executes processing of:
acquiring three-dimensional coordinate values, information on a line-of-sight direction, and point cloud data as input data and images captured from a plurality of directions as teacher data; and
learning a model for outputting an image from a designated line-of-sight direction by outputting a color and a density for each pixel using the input data and the teacher data.

7. An image processing method in which a processor executes processing of:
inputting a line-of-sight direction to a learned model for outputting an image from a designated line-of-sight direction by outputting a color and a density for each pixel using three-dimensional coordinate values, information on a line-of-sight direction, and point cloud data as input data and images captured from a plurality of directions as teacher data, and causing the model to output a color and a transmittance for each pixel from the line-of-sight direction; and
generating an image from the line-of-sight direction using the color and the transmittance.

8. A computer program for causing a computer to function as the learning device according to claim 1.

9. A computer program for causing a computer to function as the image processing device according to claim 5.

10. The learning method according to claim 6, wherein the learning unit learns the model so as to output the density for each pixel by inputting a first feature amount obtained from the point cloud data and the three-dimensional coordinate values to a predetermined first neural network, and to output the color for each pixel by inputting a feature amount obtained from the information on the line-of-sight direction and the first feature amount to a predetermined second neural network.

11. The learning device according to claim 10, wherein the first feature amount is obtained from a feature amount obtained by inputting the three-dimensional coordinate values to a predetermined third neural network and a feature amount obtained by inputting the point cloud data to a predetermined model.

12. The learning device according to claim 10, wherein the first feature amount is obtained from neighboring points set with the three-dimensional coordinate values as a center point and a feature amount obtained by inputting the point cloud data to a predetermined model.

13. The image processing device according to claim 5, wherein a plurality of model parameters of the learned model is optimized using the three-dimensional coordinate values, information on a line-of-sight direction, the point cloud data, and corrected images.

14. The image processing device according to claim 13, wherein an image is generated based on input information on generated target viewpoint entered on a trained model that has read the plurality of model parameters and using the color and transparency for the each pixel from the line-of sight direction.

15. The learning device according to claim 1, further comprising:
a learning device configured to emphasize color estimation based on local shape information and brightness information obtained from the point cloud data and assigns Red color, Green color, and Blue color based on the local shape.

16. The learning device according to claim 1, wherein the point cloud data further consisting of a point cloud and brightness information, and is used as input to the model that captures peripheral features.

17. The learning device according to claim 1, wherein a deep neural network learning is performed based on a generated image and corrected image resulting from volume rendering and the learning is performed by creating two patterns of coarse sampling and fine sampling.

18. The learning method according to claim 6, wherein during learning, the image captured at an arbitrary viewpoint is set to be the viewpoint of the correct image.

19. The learning method according to claim 6, wherein a spatial coordinate and a viewing direction are used as inputs to the model.

20. The learning method according to claim 19, wherein the spatial coordinate is further used as an input to a five-layer neural network.
